(19) United States
(12) Patent Application Publication
(10) Pub. No.: US 2020/0242917 A1
(43) Pub. Date: Jul. 30, 2020

(54) CAR SEAT SYSTEM FOR REDUCTON OF FALSE ALARMS, REDUCTION OF POWER DISSIPATION AND ITS RELEVANT OPERATION

(71) Applicant: Center for Integrated Smart Sensors Foundation, Yuseong-gu (KR)

(72) Inventors: Dong Sam Ha, Yuseong-gu (KR); Hyun Tae Cho, Yuseong-gu (KR); Jae Won Lee, Yuseong-gu (KR)

(73) Assignee: Center for Integrated Smart Sensors Foundation, Yuseong-gu (KR)

(21) Appl. No.: 16/441,404

(22) Filed: Jun. 14, 2019

(30) Foreign Application Priority Data
Jan. 30, 2019 (KR) 10-2019-0011923

(51) Int. Cl. G08B 29/18; B60N 2/00; B60N 2/26

(52) U.S. Cl. CPC G08B 29/185; B60N 2/26; B60N 2/002

(57) ABSTRACT

Disclosed is a car seat system for reducing false alarm occurrences and a method for operating the car seat system. A car seat system according to one embodiment of the inventive concept includes a sensor unit including a plurality of sensors including a pressure sensor, and sensing an object on a car seat, a sensor controller that controls a main controller to enter a wake-up mode from a sleep mode when pressure information sensed about the object is received from the pressure sensor, the main controller that, upon entering the wake-up mode by the sensor controller, determines the object based on information sensed by each of the plurality of sensors and received via the sensor controller, and provides a beacon signal about the object based on the determination, and a transmitting unit that broadcasts the beacon signal from the main controller.

### CROSS-REFERENCE TO RELATED APPLICATIONS

A claim for priority under 35 U.S.C. § 119 is made to Korean Patent Application No. 10-2019-0011923 filed on Jan. 30, 2019, in the Korean Intellectual Property Office, the entire contents of which are hereby incorporated by reference.

### BACKGROUND

Embodiments of the inventive concept described herein relate to a car seat system, and more particularly, relate to a car seat system that may reduce false alarm occurrences provided to a guardian in the car seat system and reduce power dissipation and its relevant operation.

According to recent news and the like, infants are frequently left unattended in summer in a car due to carelessness of adults and die or become unconscious. In the United States, statistics show that the average number of the infants who have been left unattended in the car and die is 37 per year over the last 20 years. When a outdoor temperature is 21° C., a temperature in the vehicle may rise to 49° C. in 10 minutes. In addition, when the outdoor temperature in summer is 30.7° C., the temperature in the car may rise to 82.4° C. in one hour.

The babies sit on a car seat equipped in the car for safety. An existing car seat system provides an alarm signal to a guardian terminal when a guardian is, by a certain distance, away from the car seat while the baby is sitting on the car seat. Therefore, the safety of the baby may be checked.

However, existing techniques may provide a false alarm, which provides an alarm to the guardian terminal even when an article or the like is sitting on the car seat.

Therefore, there is a need for a car seat system that may reduce false alarm occurrences.

### SUMMARY

Embodiments of the inventive concept provide a car seat system that may reduce false alarm occurrences provided to a guardian in the car seat system and a method to reduce power dissipation and its relevant operation.

According to an exemplary embodiment, a car seat system includes a sensor unit including a plurality of sensors including a pressure sensor, and sensing an object on a car seat, a sensor controller that controls a main controller to enter a wake-up mode from a sleep mode when pressure information sensed about the object is received from the pressure sensor, the main controller that, upon entering the wake-up mode by the sensor controller, determines the object based on information sensed by each of the plurality of sensors and received via the sensor controller, and provides a beacon signal about the object based on the determination, and a transmitting unit that broadcasts the beacon signal from the main controller.

According to an exemplary embodiment, the sensor unit may include a plurality of pressure sensors. Upon entering the wake-up mode, the main controller may determine whether the object is a baby or an article based on change in sensing values from the plurality of pressure sensors, and provide the beacon signal about the object upon determination that the object is the baby.

According to an exemplary embodiment, the sensor unit may include at least one of a motion detecting sensor, a sound detecting sensor, an ultrasonic sensor, and a temperature sensor, and the pressure sensor. Upon entering the wake-up mode, the main controller may wake up the at least one sensor, determine whether the object is a baby or an article based on sensed information sensed by the at least one sensor, and provide the beacon signal corresponding to the object upon determination that the object is the baby.

According to an exemplary embodiment, upon determination that the object is a baby based on the sensed information sensed by each of the plurality of sensors, the main controller may broadcast a beacon signal having a header containing a company identifier (ID) and a device identifier (ID) corresponding to the car seat via the transmitting unit.

According to an exemplary embodiment, the car system may further include a user terminal that scans a QR code or barcode including the company identifier and the device identifier of the corresponding car seat to register the company identifier and the device identifier, and receives the beacon signal.

According to an exemplary embodiment, the user terminal may provide an alarm signal to a user of the terminal when the object is the baby and the user terminal is, by a certain distance, away from the corresponding car seat.

According to an exemplary embodiment, when the user terminal is, by a certain distance, away from the corresponding car seat, and temperature information is contained in the beacon signal, the user terminal may reflect the temperature information to adjust a period at which the alarm signal is provided.

According to an exemplary embodiment, the user terminal may transmit location information of the user terminal and the alarm signal to at least one or more pre-registered terminals.

According to an exemplary embodiment, a method for operating a car seat system includes sensing an object on a car seat using a pressure sensor, allowing a main controller to enter a wake-up mode from a sleep mode when the object is sensed by the pressure sensor, determining, by the main controller entered the wake-up mode, whether the object is a baby or an article, based on sensed information sensed by a plurality of sensors, and broadcasting a beacon signal about the object upon determination that the object is the baby.

According to an exemplary embodiment, the determining of whether the object is the baby or the article may include determining, by the main controller, whether the object is the baby or the article based on change in values sensed from a plurality of pressure sensors.

According to an exemplary embodiment, the determining of whether the object is the baby of the article may include waking up, by the main controller, at least one of a motion detecting sensor, a sound detecting sensor, an ultrasonic sensor, and a temperature sensor, and determining, by the main controller, whether the object is the baby or the article based on sensed information sensed by the at least one sensor.

According to an exemplary embodiment, the broadcasting of the beacon signal about the object may include broadcasting a beacon signal having a header containing a company identifier (ID) and a device identifier (ID) corresponding to the car seat when the object is the baby.

According to an exemplary embodiment, the method may further include scanning, by a user terminal, a QR code or barcode including the company identifier and the device identifier of the corresponding car seat to register the company identifier and the device identifier, and receiving, by the user terminal, the beacon signal including the registered company identifier and the registered device identifier.

According to an exemplary embodiment, the method may further include providing, by the user terminal, an alarm signal to a user when the object is the baby and the user terminal is, by a certain distance, away from the corresponding car seat.

According to an exemplary embodiment, the providing of the alarm signal may include, when the user terminal is, by a certain distance, away from the corresponding car seat, and temperature information is contained in the beacon signal, reflecting the temperature information to adjust a period at which the alarm signal is provided.

According to an exemplary embodiment, the method may further include transmitting location information of the user terminal and the alarm signal to at least one or more pre-registered terminals when providing the alarm signal to the user.

### BRIEF DESCRIPTION OF THE FIGURES

The above and other objects and features become apparent from the following description with reference to the following figures, wherein like reference numerals refer to like parts throughout the various figures unless otherwise specified, and wherein:

FIG. 1 is an exemplary diagram for illustrating a car seat system of the inventive concept;

FIG. 2 is a block diagram of a car seat system according to an embodiment of the inventive concept;

FIG. 3 is a block diagram of a sensor unit illustrated in FIG. 2;

FIG. 4 is an exemplary diagram of a beacon signal;

FIG. 5 is an exemplary diagram illustrating a process for registering a car seat system;

FIGS. 6A and 6B are exemplary diagrams illustrating a case in which a guardian is with a baby in a car in a system and a case in which a guardian is away from the car; and

FIG. 7 is a flow chart of a method for operating a car seat system according to an embodiment of the inventive concept.

### DETAILED DESCRIPTION

The features and advantages of the inventive concept, and a method for achieving those will become apparent from the following description of the following embodiments given in conjunction with the accompanying drawings. However, the inventive concept is not limited to the embodiments disclosed below, but may be implemented in various forms. The embodiments of the inventive concept are only provided to make the disclosure of the inventive concept complete and fully inform those skilled in the art to which the inventive concept pertains of the scope of the inventive concept. The inventive concept is only defined by scopes of claim.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other components, steps, operations, and/or elements, in addition to the aforementioned components, steps, operations, and/or elements.

Unless otherwise defined, all terms used herein, including technical or scientific terms, have the same meanings as those generally understood by those skilled in the art to which the inventive concept pertains. Such terms as those defined in a generally used dictionary are not to be interpreted as having ideal or excessively formal meanings unless clearly defined as having such in the inventive concept.

Hereinafter, embodiments of the inventive concept will be described in detail with reference to the accompanying drawings. The same reference numerals denote the same components in the drawings, and redundant descriptions for the same components will be omitted.

The embodiments of the inventive concept determine whether an object sitting on a car seat in a car seat system is a baby or an article and provide a beacon signal to a guardian terminal only when the object is determined as the baby. Thus, a wrong beacon is prevented from being provided. The embodiments of the inventive concept allow a main controller, a transmitting unit, for example, a transmitter to enter a wake-up mode from a sleep mode only when the object is sitting on the car seat. Therefore, unnecessary power consumption is reduced.

In this connection, in accordance with the inventive concept, when the car seat system broadcasts a beacon signal containing a company identifier and a device identifier, at least one user terminal which has scanned and registered a QR code or a barcode corresponding to the car seat system may receive the broadcasted beacon signal. That is, when a guardian, for example, a father or a mother, who registered the corresponding car seat system leaves the baby in the car and is away from the baby by a certain distance, the inventive concept may generate an alarm in an application of the inventive concept installed in a guardian (the user) terminal to notify the guardian.

Further, the user terminal may transmit location information of the user terminal and an alarm signal to pre-registered terminals. That is, the inventive concept provides the alarm signal to several people who registered the car seat system, such as baby's father, mother, grandfather, grandmother, etc., such that several people may quickly check a baby's condition.

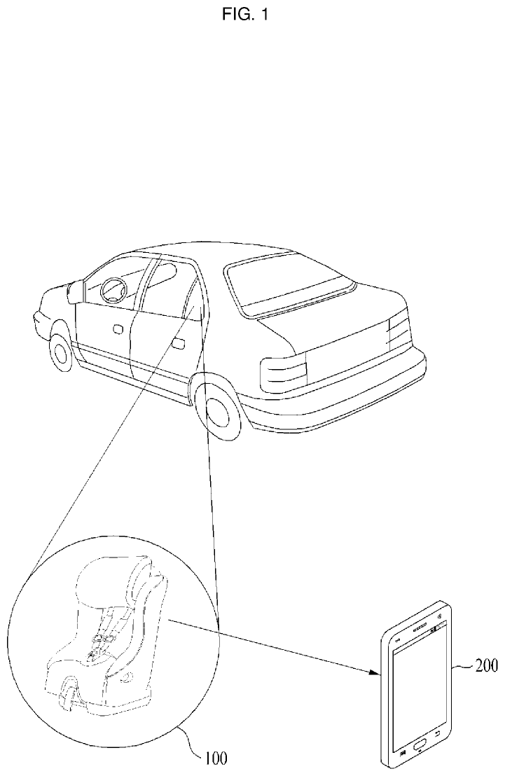

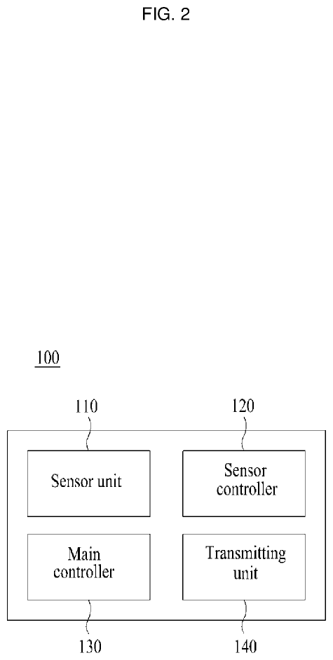

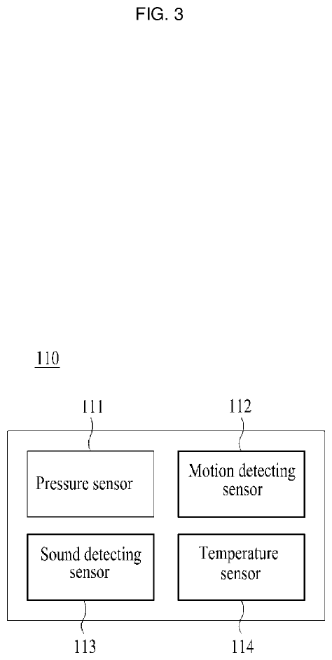

FIG. 1 is an exemplary diagram for illustrating a car seat system of the inventive concept. Further, FIG. 2 is a block diagram of a car seat system according to an embodiment of the inventive concept. Further, FIG. 3 is a block diagram of a sensor unit illustrated in FIG. 2.

With reference to FIGS. 1 to 3, a car seat system according to an embodiment of the inventive concept is installed in a car. When a distance from a predetermined guardian terminal is equal to or more than a predetermined distance, a beacon signal is broadcasted to at least one user terminal 200 which scanned and registered a QR code or a barcode attached to a car seat system 100.

Specifically, the car seat system 100 may include a sensor unit 110, a sensor controller 120, a main controller 130, and a transmitting unit 140. The sensor unit 110 may dispose a pressure sensor 111 or a pressure sensor array under a seat on which a baby sits. Further, the sensor unit 110 may dispose other sensors, such as a motion detecting sensor 112, a sound detecting sensor 113, a temperature sensor 114, and an ultrasonic sensor, at appropriate positions. Of course, the sensor controller 120, the main controller 130, the transmitting unit 140, a power supply (not shown) for supplying power, and the like may be disposed at appropriate positions in consideration of safety, inconvenience, and the like of the baby.

The sensor unit 110 senses an object, for example, an article or the baby sitting on a car seat, and provides sensed information to the sensor controller.

The car seat system 100 according to the inventive concept may maintain only a wake-up state of the sensor unit 110 and the sensor controller 120 in order to reduce unnecessary power consumption, and operate the main controller 130 and the transmitting unit 140, which consume a lot power, in a sleep mode. The main controller 130 and the transmitting unit 140 may enter a wake-up mode by the sensor controller 120. For example, upon determination that the object is sitting on the car seat from a sensed value sensed by the pressure sensor of the sensor unit 110, the sensor controller 120 may control the main controller 130 to enter the wake-up mode. In this connection, the transmitting unit 140 may enter the wake-up mode by the main controller 130.

The sensor unit 110 may operate only the pressure sensor 111 in the wake-up mode and operate the remaining sensors in the sleep mode before the object sits on the car seat, that is, when the car seat is empty. Of course, all the sensors constituting the sensor unit 110 may be operated in the wake-up mode at all times. This may be determined by a provider providing a technology of the inventive concept.

The pressure sensor 111 may be constituted by one pressure sensor or by a pressure sensor array. When the object, for example, the article or the baby sits on the car seat, the pressure sensor 111 senses a pressure value and provides sensed information about the pressure value to the sensor controller.

The motion detecting sensor 112 senses a motion of the object sitting on the car seat and provides sensed information about the motion to the sensor controller 120. Further, the sound detecting sensor 113, for example, a microphone senses a sound generated from the object and provides sensed information about the sound to the sensor controller 120. Further, the temperature sensor 114 senses a temperature of the object and provides sensed information about the temperature to the sensor controller 120.

In this connection, the motion detecting sensor 112, the sound detecting sensor 113, and the temperature sensor 114 are sensors for sensing additional information for determining whether the object is the baby or the item. The sensors for sensing the additional information are not limited thereto, and may include variety of sensors that may be applied in the inventive concept, such as an ultrasonic sensor, and the like.

The motion detecting sensor 112, the sound detecting sensor 113, and the temperature sensor 114 may enter the wake-up mode from the sleep mode by the main controller 130 depending on a situation. In addition, sensed information after entering the wake-up mode may be provided to the sensor controller.

Upon detecting that the object is sitting on the car seat by the pressure sensor 111 of the sensor unit 110, the sensor controller 120 controls the main controller 130 to enter the wake-up mode from the sleep mode, thereby providing sensed information sensed by the sensor unit 110 to the main controller.

In this connection, the sensor controller 120 may set sensor parameters such as sensitivity of each sensor. The sensor parameters may be set in consideration of baby information such as weight, height, age, gender, etc. of the baby sitting on the car seat. Of course, these sensor parameters may be set directly by a user input or by the provider. For example, the car seat system may be equipped with a receiving unit as well as the transmitting unit. Further, the baby information may be input in an application of the inventive concept installed in a guardian terminal and the baby information may be transmitted to the car seat system. In this case, the sensor parameters may be set automatically based on the baby information received from the car seat system.

Further, the sensor controller 120 may provide the sensed information sensed by all the sensors constituting the sensor unit 110 to the main controller 130, which entered the wake-up mode.

In this connection, the sensor controller 120 may provide the sensed information sensed from the sensor unit 110 to the main controller 130 in real time or at a predetermined time period. For example, when the object sitting on the car seat is determined as the article other than the baby by the main controller 130, the sensor controller 120 may provide the sensed information at the predetermined time period instead of in real time. Further, when the object is determined as the baby, the sensor controller 120 may provide the sensed information in real time.

Upon entering the wake-up mode by the sensor controller 120, the main controller 130 determines whether the object sitting on the car seat is the baby or the article based on the sensed information received from the sensors constituting the sensor unit 110 and received from the sensor controller 120. When the object is determined as the baby, the main controller 130 broadcasts the beacon signal via the transmitting unit 140.

In this connection, when the object is determined to be the baby after entering the wake-up mode, the main controller 130 may control the transmitting unit 140 to change the mode thereof from the sleep mode to the wake-up mode. In one example, depending on the situation, the transmitting unit 140 may enter the wake-up mode when the main controller 130 enters the wake-up mode.

The configuration has been described in which the main controller 130 is configured such that all the sensors constituting the sensor unit 110 are in the wake-up state, and then sense the object in real time from a time when the object sits on the seat. However, the inventive concept is not limited thereto. When only the pressure sensor constituting the sensor unit 110 maintains the wake-up state, and the remaining sensors are in the sleep mode, the remaining sensors may enter the wake-up mode by the main controller.

For example, as shown in FIG. 3, in a state where only the pressure sensor 111 of the sensor unit 110 is in the wake-up state and the remaining sensors, i.e., the motion detecting sensor 112, the sound detecting sensor 113, and the temperature sensor 114 are in the sleep mode, when the main controller 130 enters the wake-up mode by the sensor controller 120, the main controller 130 may control the sensors in the sleep mode to enter the wake-up state, thereby receiving, via the sensor controller 120, the additional sensed information to determine whether the object is the baby or the item.

That is, when the sensed information corresponding to the baby sound is received via the sound detecting sensor 113, the main controller 130 may determine that the baby is crying or talking. Further, when the sensed information corresponding to the body temperature of the baby is received via the temperature sensor 114 and the sensed information corresponding to the motion is received via the motion detecting 112, the main controller 130 may determine that the baby is moving.

As described above, the main controller 130 may control the additional sensors to enter the wake-up state to acquire the additional sensed information for determining the object. Then, the main controller 130 may easily determine whether the object is the baby or the article using the additional sensed information thus acquired. Of course, the main controller 130 may additionally determine whether the baby is crying, talking, sleeping, or moving when the object is determined as the baby, not limited to determining whether the object is the baby or the item.

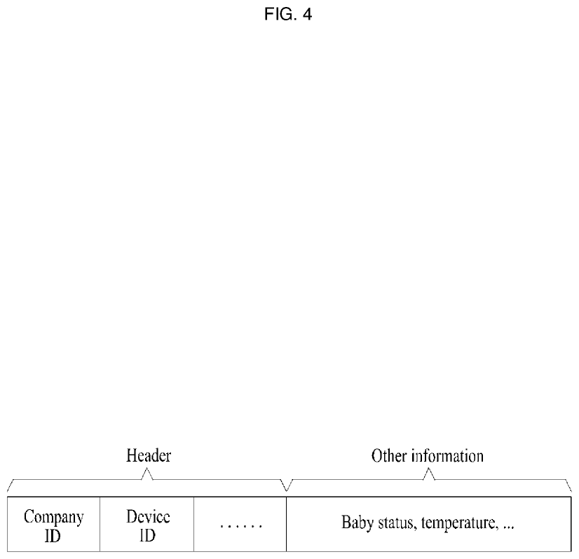

Moreover, when the object is determined as a baby, the main controller 130 contains a company identifier (company ID) and a device identifier (device ID) in a header as shown in FIG. 4, and broadcasts a beacon signal containing a message containing baby status and other information via the transmitting unit. In this connection, the beacon signal may contain temperature information. The user terminal 200 estimates a temperature inside the car with the baby over time using machine learning and the like, and then provides the temperature information while providing the alarm.

Moreover, the receiving unit may be installed in the car seat system 100. In this case, a situation in which the user is, by a certain distance, away from the car seat system while the pre-registered user terminal is left in the car may be considered. In this connection, upon determining, using an acceleration sensor and the like in the application installed in the terminal, that the car is stopped, and that there is no motion of the terminal for a predetermined time, the main controller 130 may provide information about this situation to the receiving unit of the car seat system. Therefore, the main controller 130 may broadcast a beacon signal containing the information via the transmitting unit.

As described above, the car seat system 100 according to the inventive concept further senses not only the pressure of the object but also a behavior, motion, pattern, and the like of the object, thereby determining whether the object is the baby or not. Then, the car seat system 100 broadcasts the beacon signal only when the object is the baby. Thus, an occurrence of a false alarm generated by the pre-registered user terminal may be reduced. In addition, the main controller 130, the transmitting unit 140, and the like, which consume a lot power may be operated in the sleep mode. Further, the main controller 130, the transmitting unit 140, and the like may enter the wake-up mode only when the object is detected. Thus, the power consumption may be reduced.

The inventive concept broadcasts the beacon signal. Thus, a terminal desired to receive the beacon signal must register a corresponding car seat system. This will be described as follows.

The user terminal 200 may include not only a terminal registered in the car seat system but also at least one terminal with information about the car seat system registered therein. The user terminal must register the information about the car seat system in advance.

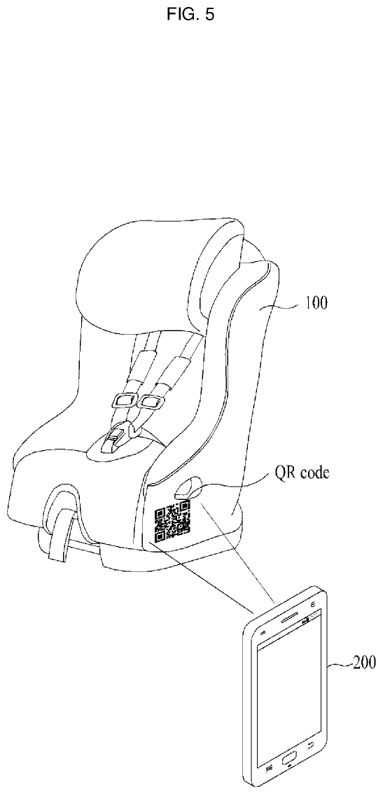

For example, as shown in FIG. 5, the user terminal 200 may scan the QR code, the barcode, and the like attached to the corresponding car seat system via the application installed in association with the inventive concept to analyze the company ID and the device ID stored in the QR code. Then, the user terminal 200 registers the company ID and the device ID thus analyzed in the corresponding app to allow the beacon signal containing the corresponding company ID and the device ID to be received.

The pre-registered user terminal 200 receives the broadcasted beacon signal. When being, by a certain distance, away from the car seat system while leaving the baby in the car, the user terminal 200 generates an alarm signal. Of course, the user terminal 200 may filter only pre-registered company ID and device ID among the broadcasted beacon signals to receive the broadcasted beacon signal from the corresponding car seat system. Then, the user terminal 200 may use the beacon signal thus received to recognize the information about the baby state, for example, the temperature inside the car, the body temperature of the baby, and the like.

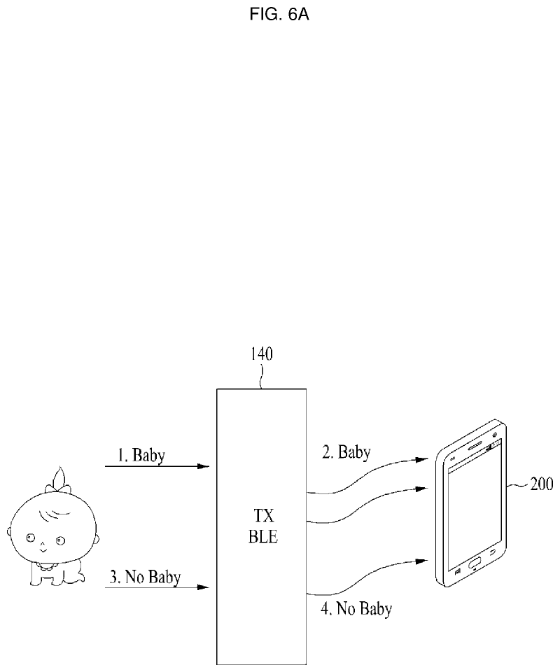

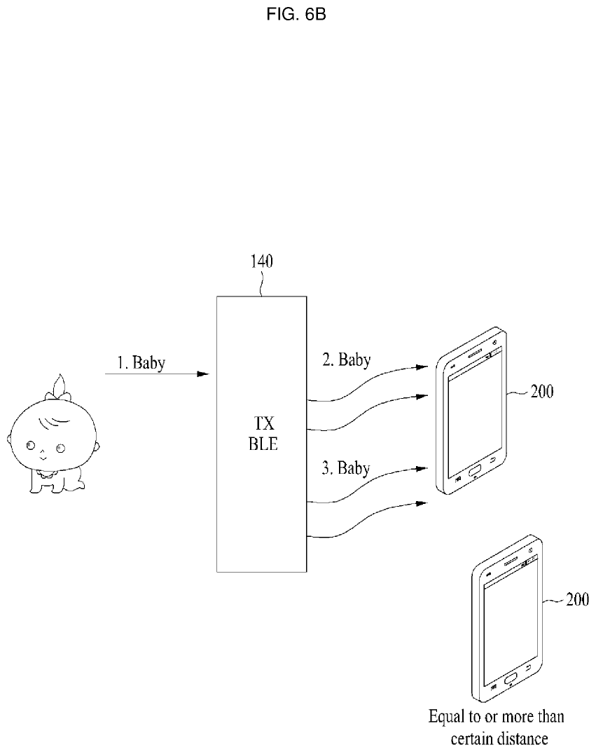

In one example, as shown in FIG. 6A, in a case 1 in which the user terminal 200 is in the car with the baby, and the baby is sitting on the car seat system, a beacon signal indicating that the baby is sitting on the car seat system is broadcasted via the transmitting unit 140. In a case 2, the user terminal receives the beacon signal and recognizes that the baby is sitting on the car seat system. In a case 3 in which the guardian lifts the baby, and the baby leaves the car seat system, the car seat system broadcasts a beacon signal indicating that the baby is no longer on the car seat system for a proper period of time. In a case 4, the user terminal 200 receives the beacon signal indicating that the baby is no longer on the car seat system, and recognizes that the baby has left from the car seat system. After a proper period of time, the car seat system stops broadcasting the beacon signal.

In another example, FIG. 6B illustrates a case in which the user carrying the user terminal has left the car while the baby is sitting on the car seat system. In a case 1, a beacon signal indicating that the baby is sitting on the car seat system is broadcasted via the transmitting unit 140. In a case 2, the user terminal receives the beacon signal and recognizes that the baby is sitting on the car seat system. In a case 3, the beacon signal indicating that the baby is sitting on the car seat system is continuously broadcasted. However, the user does not receive the beacon signal any longer since the user has left the car while leaving the baby in the car and the user terminal is, by a certain distance, away from the car seat system. In this case, the user terminal may generate the alarm and notify the user. Thus, the user may recognize that the user has been, by a certain distance, away from the baby.

Further, when the alarm signal contains the temperature information and the user is, by a certain distance, away from the car, the user terminal 200 may adjust an alarm period in consideration of the temperature information. For example, upon determination that the user terminal is, by a certain distance, away from the car, and that the temperature information is equal to or higher than a certain temperature such that a risk may increase, the application of the user terminal 200 may shorten the alarm period and provide the alarm to the user.

Further, when the user leaves the baby in the car and moves away from the baby by the certain distance, the application of the user terminal provides the alarm signal to the user. At the same time, the application of the user terminal transmits location information of the guardian, for example, a father, (GPS information about the father's terminal) to a terminal of a person other than the guardian as registered in advance, such as a mother, grandfather, grandmother, and the like. Therefore, the mother, grandfather, and grandmother other than the father may recognize this situation.

Furthermore, when a beacon signal indicating that the baby is crying received by the terminal 200 while the user terminal 200 is, by a certain distance, away from the car, the user terminal 200 may provide to the user the alarm and an indication that the baby is crying. When a beacon signal indicating that the baby is sleeping is received by the terminal 200 while the user terminal 200 is, by a certain distance, away from the car, the user terminal 200 may provide, to the user, the alarm and a notification that the baby is sleeping.

In this connection, since the user terminal 200 includes all the pre-registered terminals including the company ID and the device ID therein, people other than one person may receive the beacon signal at the same time. Therefore, people may check the alarm signal to identify that the baby has been left unattended quickly, which may allow any problems that may arise with the baby to be fixed quickly. That is, the inventive concept may allow everyone who has registered in advance to receive the alarm message through the multicasting.

Thus, the car seat system according to the embodiment of the inventive concept determines whether the object sitting on the car seat in the car seat system is the baby or the item, and provides the beacon signal to the guardian terminal only when the object is determined to be the baby. Thus, the occurrence of the false alarm is prevented. Further, the car seat system according to the embodiment of the inventive concept allows the main controller, the transmitting unit, for example, a transmitter to enter the wake-up mode from the sleep mode, only when the object is sitting on the car seat. Thus, unnecessary power consumption may be reduced.

In addition, the system according to the embodiment of the inventive concept broadcasts the beacon signal including the company ID and the device ID in the car seat system. Then the at least one terminal that has scanned and registered the QR code or the barcode corresponding to the car seat system may receive the corresponding beacon signal. Thus, the guardian may check safety of the baby.

Further, the car seat system according to the embodiment of the inventive concept does not wake up all the sensors, but wakes up the sensors in a certain order or priority. Accordingly, the additional information may be received sequentially, thereby determining whether the object is the baby or the item.

In addition, the car seat system according to the embodiment of the inventive concept may determine the object as the baby or a pet based on change in sensing values from the plurality of pressure sensors or from the plurality of sensors, for example, change in the pressure, change in the sound, change in the motion, and the like.

In addition, the car seat system according to the embodiment of the inventive concept may include a circuit to remove noise, etc., which may be caused by the motion of the baby. Further, the car seat system according to the embodiment of the inventive concept may determine the object using the additional information about the object's behavior, and the like as well as weight information to reduce the number of the false alarm occurrences. This may solve many problems that may arise from the false alarm.

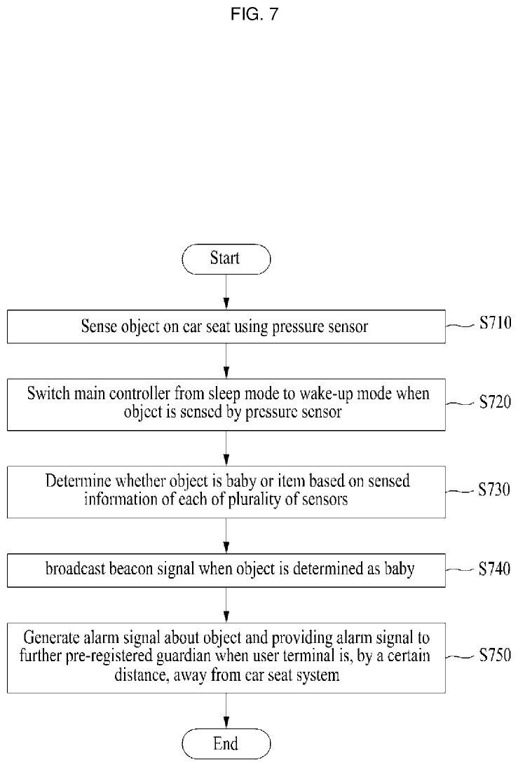

FIG. 7 illustrates a flow chart of a method for operating a car seat system according to one embodiment of the inventive concept. FIG. 7 illustrates a flowchart of the system in FIGS. 1 to 6.

With reference to FIG. 7, according to one embodiment of the inventive concept, a method of operating the car seat system uses the pressure sensor or the pressure sensor array constituting the sensor unit to sense whether the object is sitting on the car seat (S710).

When the object is sensed to be on the car seat in S710, the main controller is allowed to enter the wake-up mode from the sleep mode such that whether the object is the baby or the article may be determined (S720).

In this connection, S720 may determine whether the object is the baby or the article based on the change in sensor values from the plurality of pressure sensors or from the various kinds of sensors. The main controller may wake up at least one of the motion detecting sensor, the sound detecting sensor, the ultrasonic sensor, and the temperature sensor, and then determine whether the object is the baby or the article based on the sensed information sensed by the at least one sensor.

Upon entering the wake-up mode, the main controller receives the sensed information sensed by each of the plurality of sensors constituting the sensor unit. The main controller determines whether the object on the car seat is the baby or the article based on the received sensed information of each of the plurality of sensors (S730).

When the object is determined as the baby in S730, the beacon signal constituted by the header containing the company ID and the device ID and a baby status message is broadcasted (S740).

In this connection, the beacon signal in which the company ID and the device ID corresponding to the car seat system are contained in the header may be broadcasted in S740. The beacon signal thus broadcasted may be received by the user terminal which has registered the company ID and the device ID therein in advance, and may be provided to the corresponding user.

The application of the user terminal continuously receives the beacon signal including the corresponding company ID and the device ID. In addition, upon determination that the user terminal is, by a certain distance, away from the car seat system, the alarm signal indicating that the baby is in the car is generated and provided to the user (S750).

An operation of registering the company ID and the device ID corresponding to the car seat system in the user terminal scans the QR code, barcode, or the like attached to the corresponding car seat system through the application installed in association with the inventive concept to analyze the company ID and device ID stored in the QR code. The company ID and the device ID thus analyzed are registered in the corresponding application such that the beacon signal including the corresponding company ID and the device ID may be received. That is, when a plurality of beacon signals broadcasted are received in the state that the company ID and the device ID are pre-registered, the user terminal may be used to generate the alarm only when the beacon signal containing the pre-registered company ID and device ID among the received beacon signals is received.

Although a description thereof is omitted in the method of FIG. 7, each operation constituting FIG. 6 may include all of the contents described in FIGS. 1 to 6, which will be apparent to those skilled in the art.

The foregoing devices may be realized by hardware elements, software elements and/or combinations thereof. For example, the devices and components illustrated in the exemplary embodiments may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implementations, other embodiments, and equivalents to the claims are within the scope of the following claims.

According to the embodiments of the inventive concept, the car seat system determines whether the object sitting on the car seat is the baby or the item, and provides the beacon signal to the guardian terminal only when the object is determined as the baby. Thus, a wrong beacon may be prevented from being provided. The main controller, the transmitting unit, for example, the transmitter enters the wake-up mode from the sleep mode only when the object is sitting on the car seat. Therefore, the unnecessary power consumption may be reduced.

According to the embodiments of the inventive concept, the car seat system broadcasts the beacon signal including the company ID and the device ID. The at least one user terminal which has scanned and registered the QR code or the barcode corresponding to the car seat system may receive the corresponding beacon signal. Thus, the safety of the baby may be checked by the several people.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A car seat system comprising:
a sensor unit including a plurality of sensors including a pressure sensor, wherein the sensor unit senses an object on a car seat;
a sensor controller configured to control a main controller to enter a wake-up mode from a sleep mode when pressure information sensed about the object is received from the pressure sensor;
the main controller configured to, upon entering the wake-up mode by the sensor controller, determine the object based on information sensed by each of the plurality of sensors and received via the sensor controller, and provide a beacon signal about the object based on the determination; and
a transmitting unit configured to broadcast the beacon signal from the main controller.

2. The car system of claim 1, wherein the sensor unit includes a plurality of pressure sensors, and
wherein, upon entering the wake-up mode, the main controller is configured to determine whether the object is a baby or an article based on change in sensing values from the plurality of pressure sensors, and for providing the beacon signal about the object upon determination that the object is the baby.

3. The car system of claim 1, wherein the sensor unit includes at least one of a motion detecting sensor, a sound detecting sensor, an ultrasonic sensor, and a temperature sensor, and the pressure sensor, and
wherein, upon entering the wake-up mode, the main controller wakes up the at least one sensor, determines whether the object is a baby or an article based on sensed information sensed by the at least one sensor, and provides the beacon signal corresponding to the object upon determination that the object is the baby.

4. The car system of claim 1, wherein, upon determination that the object is a baby based on the sensed information sensed by each of the plurality of sensors, the main controller broadcasts a beacon signal having a header containing a company identifier (ID) and a device identifier (ID) corresponding to the car seat via the transmitting unit.

5. The car system of claim 4, further comprising a user terminal configured to scan a QR code or barcode including the company identifier and the device identifier of the corresponding car seat to register the company identifier and the device identifier, and for receiving the beacon signal.

6. The car system of claim 5, wherein the user terminal provides an alarm signal to a user of the terminal when the object is the baby and the user terminal is, by a certain distance, away from the corresponding car seat.

7. The car system of claim 6, when the user terminal is, by the certain distance, away from the corresponding car seat, and temperature information is contained in the beacon signal, the user terminal reflects the temperature information to adjust a period at which the alarm signal is provided.

8. The car system of claim 6, wherein the user terminal transmits location information of the user terminal and the alarm signal to at least one or more pre-registered terminals.

9. A method for operating a car seat system, the method comprising:
sensing an object on a car seat using a pressure sensor;
allowing a main controller to enter a wake-up mode from a sleep mode when the object is sensed by the pressure sensor;
determining, by the main controller entered the wake-up mode, whether the object is a baby or an article, based on sensed information sensed by a plurality of sensors; and
broadcasting a beacon signal about the object upon determination that the object is a baby.

10. The method of claim 9, wherein the determining whether the object is the baby or the article includes determining, by the main controller, whether the object is the baby or the article based on change in values sensed from a plurality of pressure sensors.

11. The method of claim 9, wherein the determining whether the object is the baby of the article includes:
waking up, by the main controller, at least one of a motion detecting sensor, a sound detecting sensor, an ultrasonic sensor, and a temperature sensor; and
determining, by the main controller, whether the object is the baby or the article based on sensed information sensed by the at least one sensor.

12. The method of claim 9, wherein the broadcasting of the beacon signal about the object includes broadcasting a beacon signal having a header containing a company identifier (ID) and a device identifier (ID) corresponding to the car seat when the object is the baby.

13. The method of claim 12, further comprising:
scanning, by a user terminal, a QR code or barcode including the company identifier and the device identifier of the corresponding car seat to register the company identifier and the device identifier; and
receiving, by the user terminal, the beacon signal including the registered company identifier and the registered device identifier.

14. The method of claim 13, further comprising:
providing, by the user terminal, an alarm signal to a user when the object is the baby and the user terminal is, by a certain distance, away from the corresponding car seat.

15. The method of claim 14, wherein the providing of the alarm signal includes, when the user terminal is, by a certain distance, away from the corresponding car seat, and temperature information is contained in the beacon signal, reflecting the temperature information to adjust a period at which the alarm signal is provided.

16. The method of claim 14, further comprising transmitting location information of the user terminal and the alarm signal to at least one or more pre-registered terminals when providing the alarm signal to the user.
